(19) United States
(12) Patent Application Publication
(10) Pub. No.: US 2017/0140680 A1
(43) Pub. Date: May 18, 2017

(54) ELECTRONIC PLACARD

(71) Applicant: J. J. Keller & Associates, Inc., Neenah, WI (US)

(72) Inventors: Kevin Kucksdorf, Greenville, WI (US); Carol Ann O'Hern, Sturgeon Bay, WI (US)

(21) Appl. No.: 14/939,242

(22) Filed: Nov. 12, 2015

(51) Int. Cl. G09F 13/00; G09F 7/18; G09F 21/04

(52) U.S. Cl. CPC G09F 13/005; G09F 21/048; G09F 7/18; G09F 2007/1843; G09F 2007/1865

(57) ABSTRACT

A method of displaying an electronic placard on a vehicle, the method including positioning an electronic display on a vehicle, providing a controller in communication with the display, selecting a placard from a library of placards using the controller, the placards pertaining to cargo carried by the vehicle, and displaying the selected placard on the display.

### BACKGROUND

The present invention relates to a placard for use with a vehicle, and particularly to an electronic placard.

Placards are mounted on trucks and other vehicles carrying cargo. The placards communicate important information regarding the contents of cargo being transported or the hazard type associated with the cargo being transported. The information contained on the placards is particularly important when an accident or other incident occurs which may compromise the containment of the cargo and pose a risk to the driver of the vehicle or others. For example, a placard may indicate when a hazardous material is being transported by the vehicle or may indicate a hazard type, for example flammable. The information on the placard provides the driver and others with information that enables them to handle the vehicle during an incident in an appropriate manner.

The placards are generally mounted to the exterior of the vehicle and include some type of indicator identifying the characteristics of the cargo or hazard type. When drivers transport cargo from one location to another, circumstances can arise in which it is important to know the contents or hazards of the cargo being transported. For example, if a truck carrying hazardous substance is in a traffic accident that may compromise the containment of the cargo, it may be important to know how dangerous the substance is and what characteristics it may possess. By identifying the type of cargo being transported and/or hazards, professionals can better assess the incident to determine what level of precaution must be taken when addressing the incident.

Typically, placards have been one of two styles: a flip-book style or an insert style. The flip-book style placard includes a predetermined set of images that are fixed to the base of a vehicle. Before transporting the cargo in the vehicle, the driver can “flip” to the image that best identifies the contents or hazards of the cargo. The flip-book style placard is limited to the images provided in the set. When the images or information needs to be updated, the entire flip- book may be replaced. The insert style placard is not limited to a predetermined set of images, but rather, any number of inserts can be created to slide into a housing mounted on a vehicle. However, the insert style placard is limited by the number of placard inserts stored in the vehicle during transportation. For example, if a driver drops off the cargo in the truck and picks up new cargo, the driver may not have access to a placard insert that properly identifies the new cargo or its hazards. Additionally, it is often difficult to read the information presented on the flip-book style and the insert style placards in the dark.

### SUMMARY

In one embodiment, the invention provides a method of displaying an electronic placard on a vehicle, the method including positioning an electronic display on a vehicle, providing a controller in communication with the display, selecting a placard from a library of placards using the controller, where the placards relate to cargo carried by the vehicle, and displaying the selected placard on the display.

In another embodiment the invention provides a method of displaying an electronic placard on a vehicle, the method including interfacing with a smart device having access to a library of placard images relating to cargo in the vehicle, selecting a particular placard image to be displayed, and wirelessly communicating the selected placard image to an electronic display on the vehicle.

In yet another embodiment the invention provides an electronic placard system for use with a vehicle containing cargo, the placard system including an electronic display configured to be positionable on an exterior of a vehicle, and a smart device application in wireless communication with said display, said application having access to a library of placard information relating to vehicle cargo such that placard information selected using the smart device application is displayed on said display.

In yet another embodiment the invention provides an electronic placard system for use with a vehicle containing cargo, the placard system including a housing mounted to the exterior of the vehicle, an electronic display secured to said housing, and a controller secured to the housing, where the controller is in communication with said display and in communication with a library of placards pertaining to vehicle cargo, and where the placard information is selected using said controller is displayed on said display.

Other aspects of the invention will become apparent by consideration of the detailed description and accompanying drawings.

### BRIEF DESCRIPTION OF THE DRAWINGS

FIG. 1 is a schematic drawing of a placard display coupled to a vehicle.

FIG. 2 is a schematic drawing of a placard display.

FIG. 3 is a schematic diagram of a placard assembly according to an embodiment of the invention.

FIG. 4 is a schematic diagram of a placard assembly according to an embodiment of the invention.

FIG. 5 is a schematic diagram of a placard assembly according to an embodiment of the invention.

FIG. 6 is a schematic diagram of a placard assembly according to an embodiment of the invention.

FIG. 7 is a schematic diagram of a placard assembly according to an embodiment of the invention.

FIG. 8 is a schematic diagram of a placard assembly according to an embodiment of the invention.

FIG. 9 is a flow chart of a user interface according to one embodiment of the invention.

FIG. 10 is a schematic drawing of a placard assembly according to an embodiment of the invention.

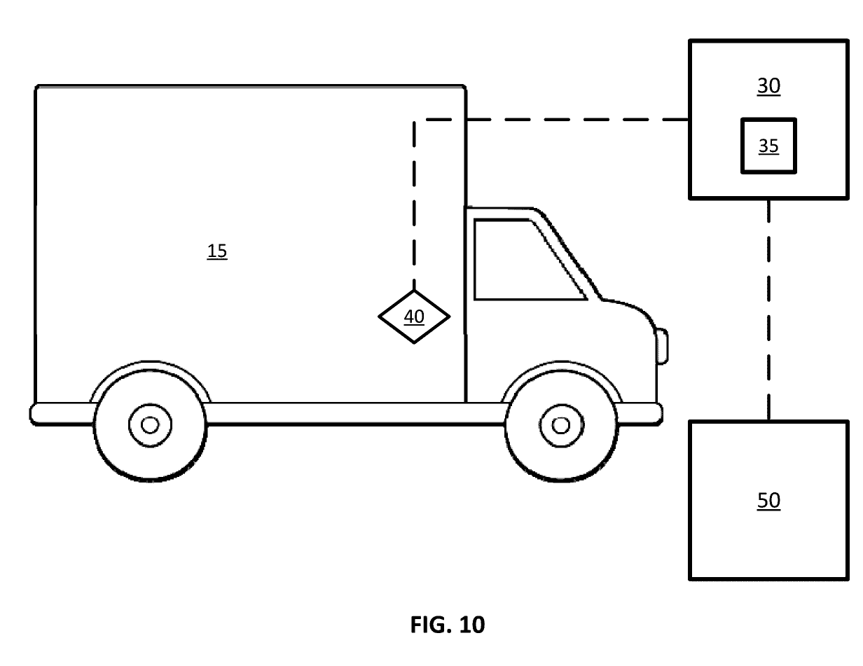

FIG. 11 is a schematic drawing of a placard assembly according to an embodiment of the invention.

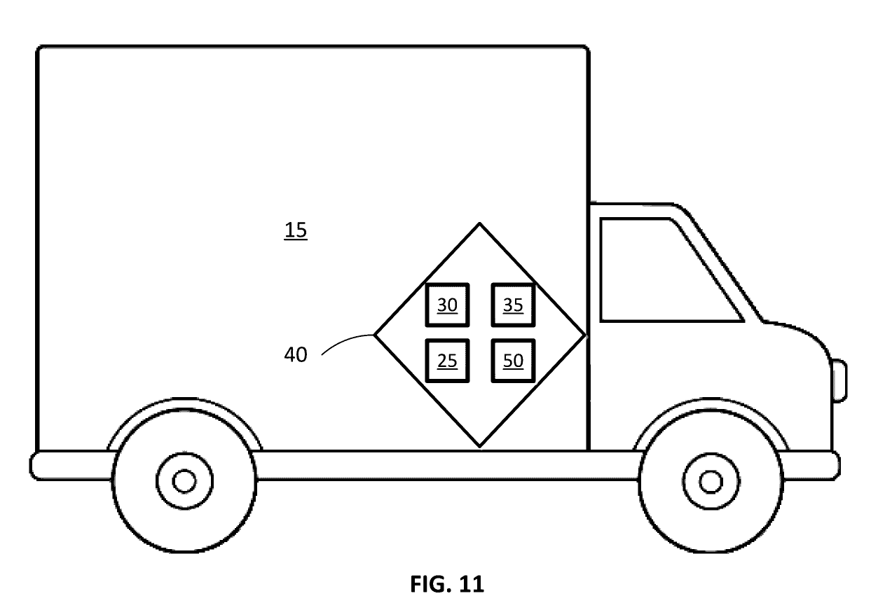

FIG. 12 is a schematic drawing of a placard assembly according to an embodiment of the invention.

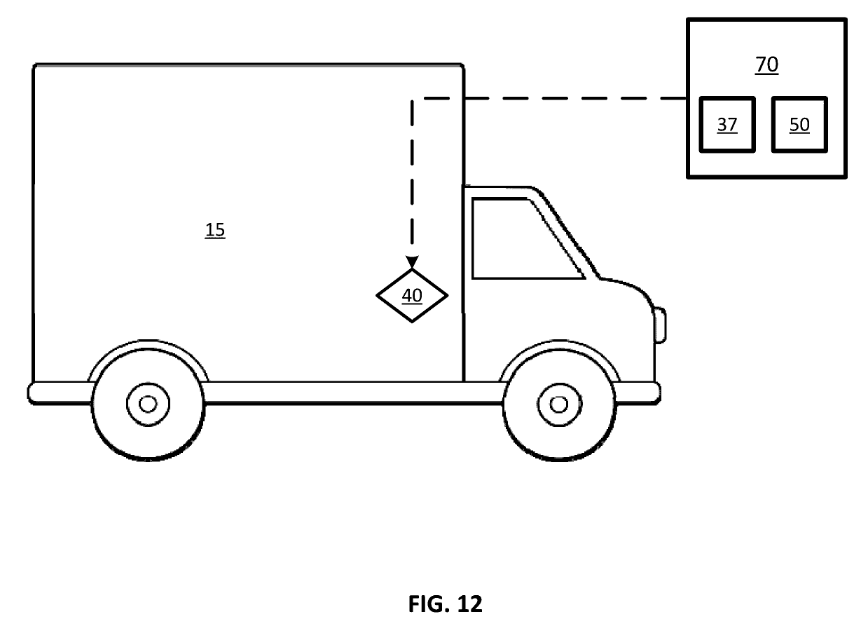

FIG. 13 is a schematic drawing of a placard assembly according to an embodiment of the invention.

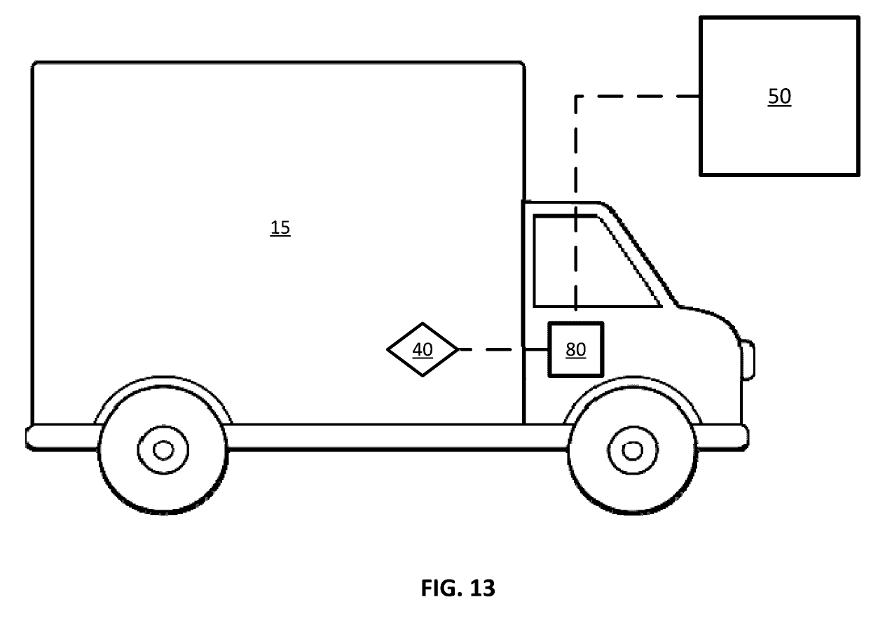

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should be noted that a plurality of hardware and software based devices, as well as a plurality of different structural components may be utilized to implement the invention. As such, it should be noted that a plurality of hardware and software based devices, as well as a plurality of different structural components may be utilized to implement the invention. For example, “controller” and “control unit” described in the specification can include one or more processors, one or more memory modules including non-transitory computer-readable medium, one or more input/output interfaces, and various connections (e.g., a system bus) connecting the components. Where the terms “controller” and “processor” are used as identifying a unit performing specific functions, it should be understood that, unless otherwise stated, those functions can be carried out by a single controller or multiple controllers arranged in any form. Furthermore, and as described in subsequent paragraphs, the specific configurations illustrated in the drawings are intended to exemplify embodiments of the invention and that other alternative configurations are possible.

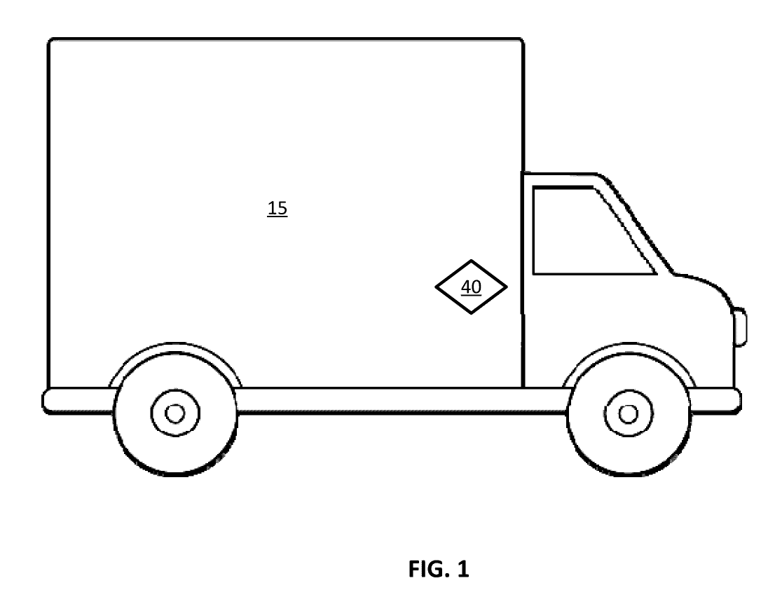

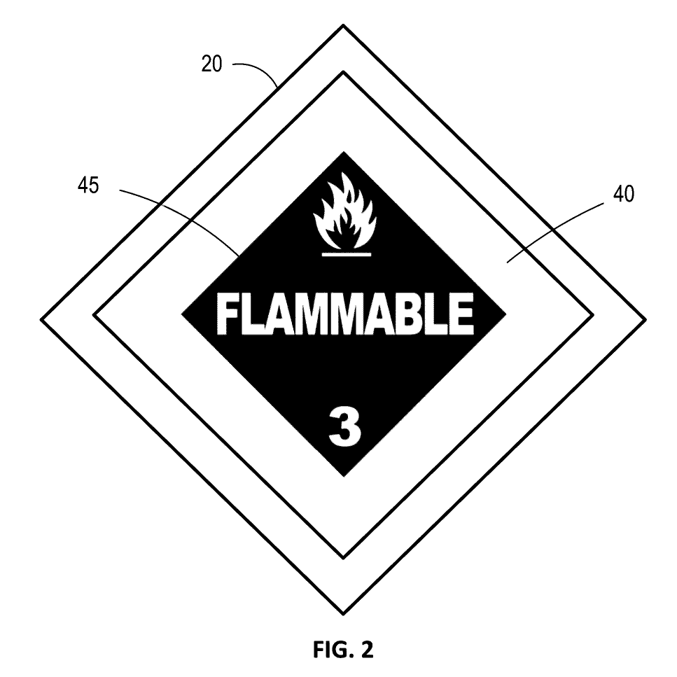

FIGS. 1 and 2 provide a schematic drawing of a single electronic placard assembly 10 coupled to a vehicle 15, with multiple assemblies 10 also being an option. The placard assembly 10 is designed to be used with any type of transportation vehicle 15 or bulk container carrying cargo to help identify the cargo or its hazards. As used in this application, the term vehicle 15 includes trucks, cars, trains, planes, ships, bulk containers and intermodal containers. The placard assembly 10 includes a housing 20 that is capable of being coupled anywhere on the exterior of the vehicle 15 and in any orientation such as on point as displayed in the drawing or any other desired orientations. An electronic display 40 is at least partially disposed within the housing 20. In some embodiments and as shown in other drawings, the placard assembly 10 includes a light 25 to illuminate the display 40. The light 25 can be an LED, LCD, back-lit or any other suitable light known in the art.

As shown in FIG. 2, the display 40 is capable of showing a placard 45. Each placard 45 includes information about cargo that may be transported by a vehicle 15, information related to a hazard relating to the cargo, or any other like information. The information on the placard 45 can be portrayed through an image, alphabetical or numerical text, a coding system, or a combination thereof. For example, FIG. 2 illustrates a placard for a flammable cargo may include an image of flames and a number characterizing the type of cargo. Likewise, a placard 45 for a poisonous chemical may include an image of cross bones and a code consisting of a combination of numbers and letters that indicate what category of chemical the vehicle 15 is carrying. A coding system may be used in conjunction with the placards 45 to help identify the cargo transported by the vehicle 15. One type of coding system that may be used is a 4-digit UN/NA number.

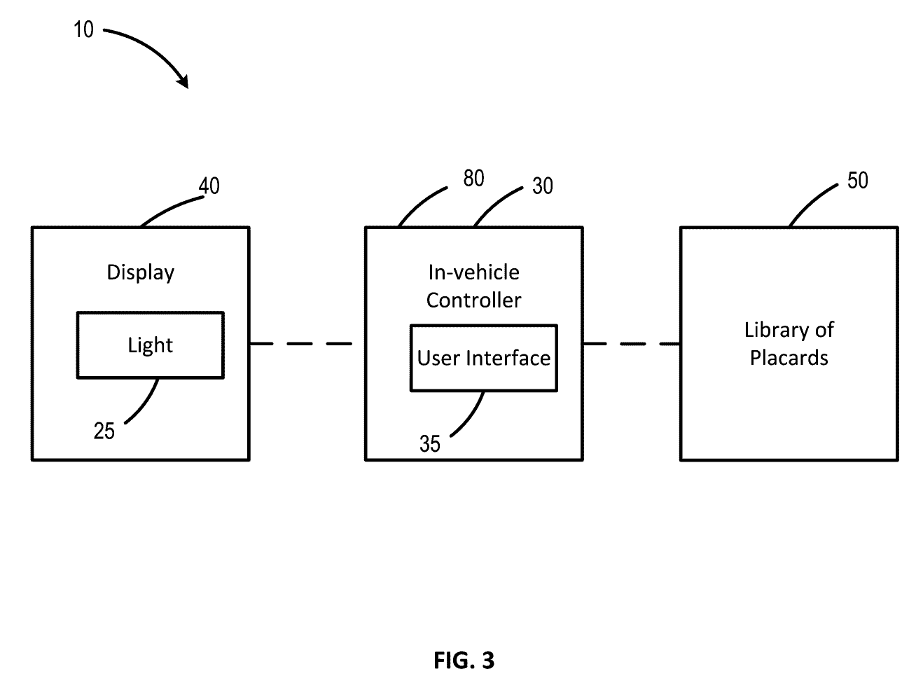

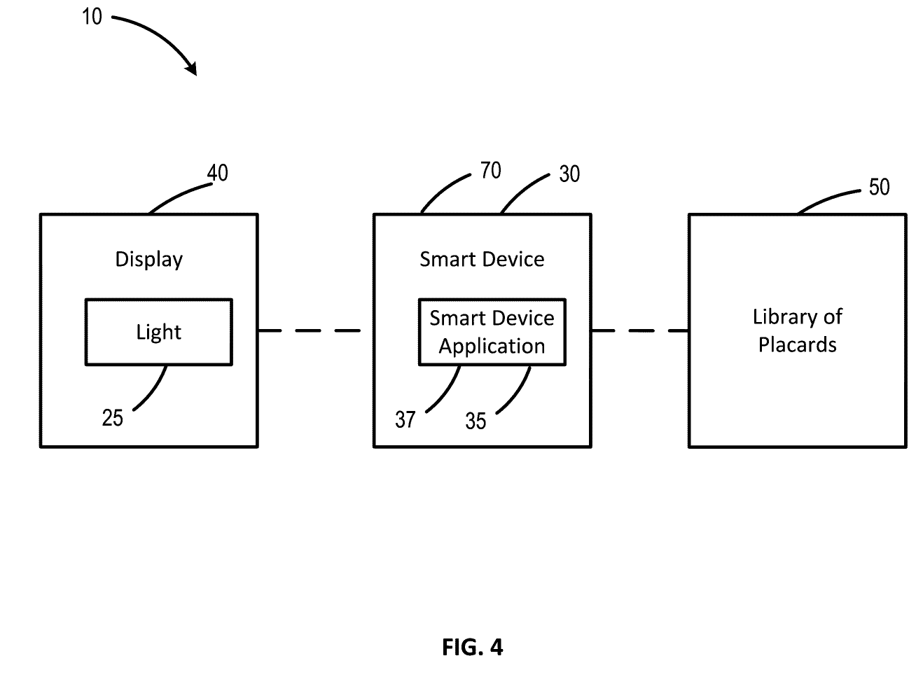

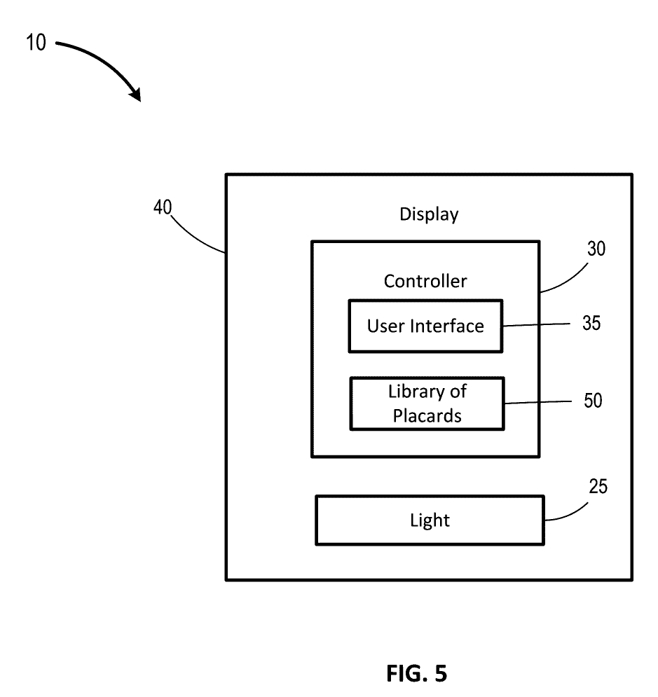

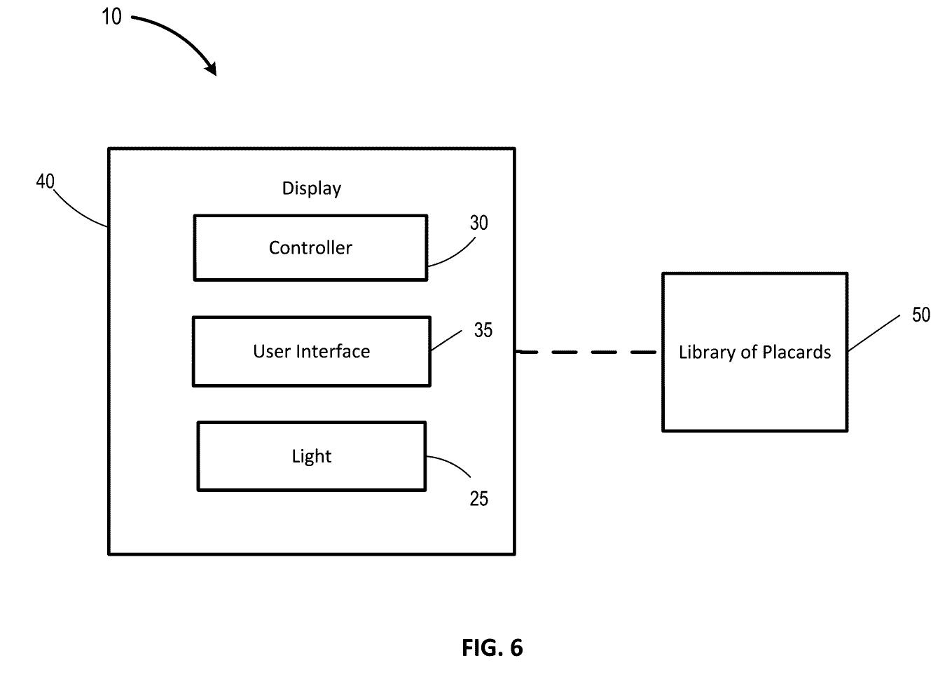

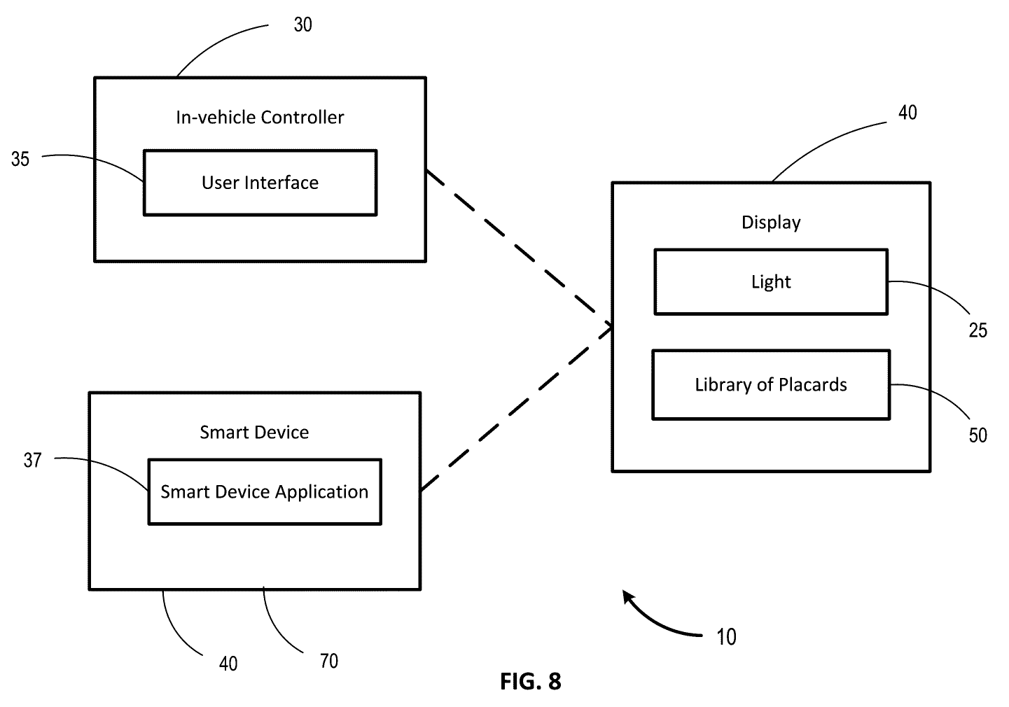

With reference to FIGS. 3-8, a controller 30 is used to operate the display 40 and control the placard 45 shown on the display 40. The controller 30 can be provided with a user interface 35 that enables a user to select the placard 45. In some embodiments, the controller 30 and the display 40 are electrically coupled together. For example, the controller 30 may be contained in the same housing 10 as the display 40, as depicted in FIGS. 5 and 6. In this case, the user interface 35 may be a part of the display 40 or may be positioned elsewhere on the housing 20. In other embodiments, the controller 30 operates the display 40 wirelessly. For example, the controller 30 may be incorporated into a smart device 70, such as cellular phone (FIGS. 4, 7, and 8), tablet, smartwatch, mounted controller, or other such device. In this embodiment, the user interface 35 is provided through a smart device application 37. Alternatively, the controller 30 and user interface 35 may be a part of an in-vehicle device 80 that is housed inside the vehicle 15 (FIGS. 3 and 8). The in-vehicle device 80 may be attached to the vehicle 15 dashboard or stored in the glove compartment. Alternately, the controller 30 can be outside of the vehicle operator's control through a separate control step remote from the vehicle 15 or vehicle operator, such as a company HQ or fleet manager.

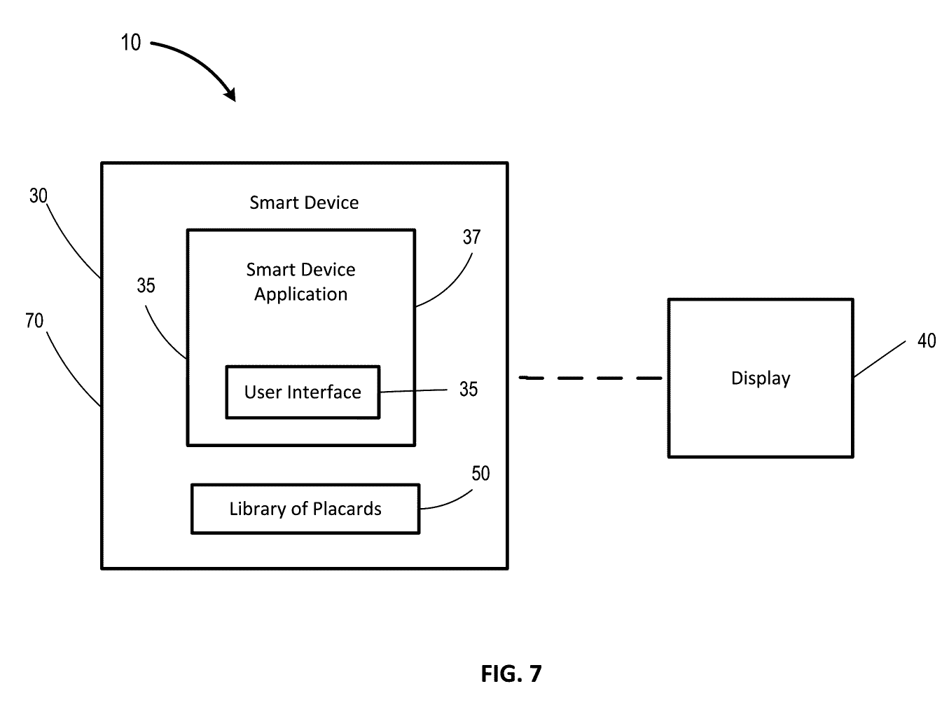

The controller 30 is in communication with a library of placards 50. The library of placards 50 contains a plurality of placards 45 that a user may select to show on the display 40. The library of placards 50 may be stored on an internal memory of the controller 30 (FIG. 5), an internal memory of the smart device application 37 (FIG. 7), and internal memory of the display (FIGS. 5 and 8), or may be stored on an external memory source (FIGS. 3 and 4). The external memory source may include a database on a computer or an internet database. In some embodiments, the external memory source is maintained by a third party company or a government agency. The library of placards 50 can include any number of placards 45. Additional placards 45 can be wirelessly uploaded to the library of placards 50. Likewise, updates to the library of placards 50 can be performed wirelessly.

It should be understood that the wireless communication of the controller 30, the display 40, and the library of placards 50 can be carried out through any variety of known wireless communication methods. For example, the controller 30 may wirelessly control the display 40 through Bluetooth communication. Similarly, the controller 30 may be in communication with the library of placards 50 via an internet connection or mobile telecommunications technology. Likewise, it should be understood that the specific placement and configuration of the controller 30, the user interface 35, and the location of the library of placards 50 can vary. In addition, in some embodiments, multiple user interfaces 35 may be incorporated within the placard assembly 10. For example, the placard assembly 10 may include a controller 30 and a user interface on a smart device 70 and in an in-vehicle device 80. FIGS. 3-8 illustrate examples of configurations of the controller 30 and user interface 35, the library of placards 50, and the display. The placard assembly 10 is not limited to the configurations illustrated in these figures.

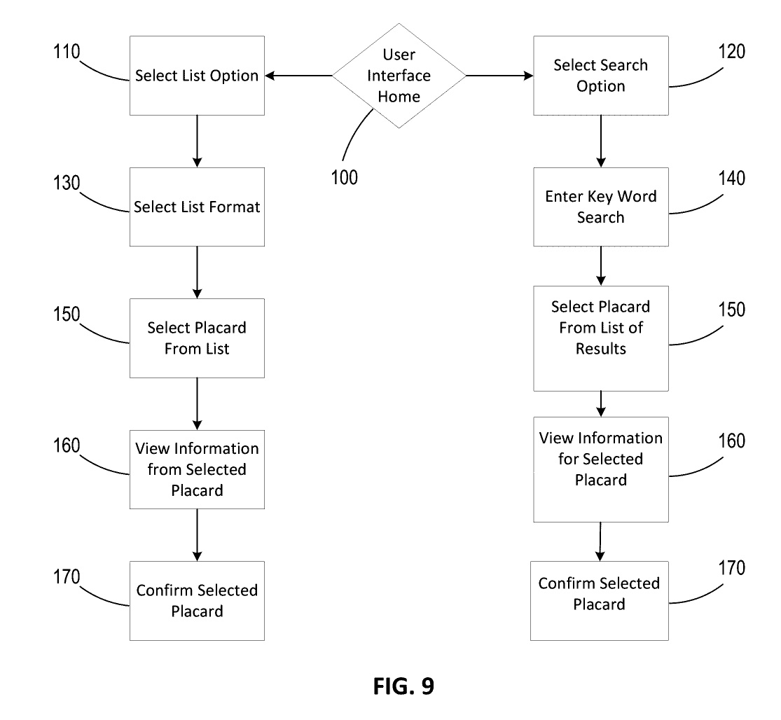

In operation, when cargo is to be stored or transported, the appropriate placard 45 corresponding to the information to be displayed is selected to be shown on the display 40. The driver utilizes the user interface 35 in order to select a placard 45. Although the user interface 35 can be operated in a number of different ways, FIG. 9 illustrates a flow chart of one embodiment of the operation of a user interface 35. In the illustrated embodiment, when the driver engages with the user interface 35, a home screen is provided with options for how the driver would like to proceed (step 100). The driver can choose to see a list of the placard 45 options (step 110) or can choose to search for a specific placard 45 (step 120). If the driver chooses to see a list of the placards 45, the driver may have an additional option of choosing the format in which the list is shown (step 130). For example, the list can be provided in consecutive order, for example, according to a numerical code or alphabetical name. The list can also be organized by category with sub-lists containing the placards 45 belonging to each category. If the driver chooses to search for a specific placard 45, the driver can enter key words into a search bar (step 140) such as “diesel fuel”. The user interface 35 will then provide a list of potential placards 45 that match the driver's search (step 140) such as “red flammable 1202”.

Once the driver identifies the appropriate placard 45 in one of the lists described, the driver will select the placard 45 to be shown on the display 40 (step 150). In some embodiments, the user interface 35 will then provide additional information about the placard 45 selected (step 160). This enables the driver to ensure that the correct placard 45 is selected. If the driver agrees with the selection, they can confirm the selection, and the controller 30 will show the selected placard 45 on the display 40 (step 170).

In some embodiments, the placard assembly 10 includes additional safety features. For example, in the case of a power outage, an accident, or some other incident which may present complications to the placard assembly 10, the display 40 automatically retains the placard 45 last shown. In some embodiment, the display 40 provides information in addition to the information presented on the placards 45. For example, a safety scoreboard may appear that provides the number of lost work days. The display 40 may provide training tips or other safety messaging. Safety messaging can include updates on safety conditions based on the current conditions of the vehicle 15, the weather, or other travel conditions, such as the roads. In some embodiments, the additional information is provided in the form of a rotating news ticker that appears on the display 40.

Various features and advantages of the invention are set forth in the following claims.

1. A method of displaying an electronic placard on a vehicle, the method comprising:
positioning an electronic display on a vehicle;
providing a controller in communication with the display;
selecting a placard from a library of placards using the controller, the placards relating to cargo carried by the vehicle; and
displaying the selected placard on the display.

2. The method of claim 1, wherein the controller is in wireless communication with the library.

3. The method of claim 1, wherein the controller includes a memory containing the library of placards.

4. The method of claim 1, wherein the placards includes at least one of a numerical code, an image, and text.

5. The method of claim 1, wherein said controller is one of a smart phone or in-vehicle device.

6. The method of claim 1, wherein therein the controller is a smart phone containing an application accesses the library.

7. The method of claim 1, wherein the controller communicates with the display via a wireless signal.

8. The method of claim 1, further including the step of retaining the display of the placard during a vehicle power outage and during a vehicle accident.

9. The method of claim 1, further including the step of illuminating the display.

10. The method of claim 1, further including the step of displaying at least one of safety training information, a safety scoreboard, and a warning signal.

11. The method of claim 1, further including the steps of mounting the display and the controller on a housing and mounting the housing to the exterior of a vehicle.

12. A method of displaying an electronic placard on a vehicle, the method comprising:
interfacing with a smart device having access to a library of placard images relating to cargo in the vehicle;
selecting a particular placard image to be displayed; and
wirelessly communicating the selected placard image to an electronic display on the vehicle.

13. The method of claim 12, wherein the smart device is one of a smart phone, tablet or smartwatch having an appropriate application loaded thereon.

14. The method of claim 12, wherein the smart device is an in-vehicle device.

15. The method of claim 12, wherein the selecting step further includes selection of a particular chemical name represented as a 4-digit UN/NA number.

16. The method of claim 12, wherein the smart devices has access to information regarding each placard image in the library which can be accessed to aid in the selecting step.

17. The method of claim 12, wherein the electronic display is an LCD screen.

18. The method of claim 12, wherein the library of placard images is updated.

19. An electronic placard system for use with a vehicle containing cargo, the placard system comprising:
an electronic display configured to be positionable on an exterior of a vehicle; and
a smart device application in wireless communication with said display, said application having access to a library of placard information relating to vehicle cargo such that placard information selected using the smart device application is displayed on said display.

20. The electronic placard system of claim 19, wherein said smart device application is housed on one of a smart phone and an in-vehicle device.

21. The electronic placard system of claim 19 and further including a light configured to illuminate said display.

22. The electronic placard system of claim 19, wherein said application includes a user interface to assist in the selecting of particular placard information.

23. The electronic placard system of claim 19, wherein said application enables a user to input a chemical name to determine the appropriate placard information to be displayed.

24. The electronic placard system of claim 19, wherein said application aids the user in selecting placard information by providing additional data relating to a particular placard information.

25. An electronic placard system for use with a vehicle containing cargo, the placard system comprising:
a housing mounted to the exterior of the vehicle;
an electronic display secured to said housing;
a controller secured to the housing, in communication with said display and in communication with a library of placards pertaining to vehicle cargo, wherein placard information selected using said controller is displayed on said display.

26. The electronic placard system of claim 25 and further including a light secured to said housing to illuminate said display.

27. The electronic placard system of claim 25, wherein said controller communicates with the library wirelessly.
